(19) United States
(12) Patent Application Publication
(10) Pub. No.: US 2006/0211589 A1
(43) Pub. Date: Sep. 21, 2006

(54) Pharmaceutical metered dose inhaler and methods relating thereto

(76) Inventors: Anne Pauline Godfrey, Ware (GB); Alexander John Murray Munro, Ware (GB)

Correspondence Address: GLAXOSMITHKLINE;CORPORATE INTELLECTUAL PROPERTY, MAI B475, FIVE MOORE DR., PO BOX 13398, RESEARCH TRIANGLE PARK, NC, 27709-3398, US

(21) Appl. No.: 10/566,457

(22) PCT Filed: Jul. 21, 2004
(86) PCT No.: PCT/US04/23466

§ 371 Date: Jan. 30, 2006

Related U.S. Application Data
(60) Provisional application No. 60/491,677, filed on Jul. 31, 2003.

(51) Int. Cl. C11D 3/20

(52) U.S. Cl. 510/161

(57) ABSTRACT

Methods of treating an elastomeric MDI sealing gasket that include washing the gasket in an alkali wash solution that is a solution of an alkali metal hydroxide in water are disclosed. Metering valves, containers, metered dose inhalers, and drug products that include such gaskets are also disclosed, as are methods of using such gaskets.

The present invention relates to methods of treating metered dose inhaler (MDI) sealing gaskets and MDI sealing gaskets made from treated materials. The invention further relates to a container for an MDI with enhanced characteristics and methods associated therewith. The MDI is typically one for use in dispensing a quantity of a medicament-containing formulation which may be used in the treatment of respiratory or other disorders.

### BACKGROUND

The use of aerosols to administer medicaments has been known for several decades. Such aerosols generally comprise the medicament, one or more chlorofluorocarbon propellants and one or more additives, for example a surfactant or a co-solvent, such as ethanol. Historically the most commonly used aerosol propellants for medicaments have been propellant 11 (CCl₃F), propellant 114 (CF₂ClCF₂Cl), propellant 12 (CCl₂F₂) or combinations of those. However release of those propellants into the atmosphere is now believed to contribute the degradation of stratospheric ozone and there is thus a need to provide aerosol formulations for medicaments which employ so called “ozone-friendly” propellants.

Containers for aerosol formulations commonly comprise a vial body (can or canister) coupled to a valve. The valve comprises a valve stem through which the formulations are dispensed. Generally the valve includes one or more rubber valve seal intended to allow reciprocal movement of the valve stem which prevents leakage of propellant from the container. Metered dose inhalers comprise a valve which is designed to deliver a metered amount of an aerosol formulation to the recipient per actuation. Such a metering valve generally comprises a metering chamber which is of a pre-determined volume and which causes the dose per actuation to be an accurate, pre-determined amount.

The metering valve in a container is typically coupled to the canister with contact through a sealing gasket to prevent leakage of propellant and/or drug substance out of the container at the join. The gasket typically comprises an elastomeric material, for example low density polyethylene, chlorobutyl, acrylonitrile butadiene rubbers, butyl rubber, a polymer of ethylene propylene diene monomer (EPDM), neoprene or chloroprene. Such elastomeric materials may be carbon-black or mineral filled.

Valves for use in MDIs are available from various manufactures known in the aerosol industry; for example from Valois, France (e.g. DF10, DF30, DF60), Bespak plc, UK (e.g. BK300, BK356, BK357) or 3M-Neotechnic Limited, UK (e.g. SpraymiserTM). The metering valves are used in association with commercially available canisters, for example metal canisters, for example aluminium canisters, suitable for delivering pharmaceutical aerosol formulations.

MDIs incorporating a valve seal or a sealing gasket as described above generally perform adequately with CFC propellants, such as propellant 11 (CCl₃F), propellant 114 (CF₂ClCF₂Cl), propellant 12 (CCl₂F₂). However, as mentioned above, there is a requirement to substitute so-called ozone-friendly propellants for CFC propellants in aerosols. A class of propellants which are believed to have minimal ozone-depleting effects In comparison to conventional chlorofluorocarbons comprise fluorocarbons and hydrogen-containing chlorofluorocarbons. That class includes, but is not limited to hydrofluoroalkanes (HFAs), for example 1,1,1,2-tetrafluoroethane (HFA134a), 1,1,1,2,31,3,3-heptafluoro-n-propane (HFA 227) and mixtures thereof. However, various problems have arisen with pharmaceutical aerosol formulations prepared using HFA propellants, in particular with regard to the stability of the formulations.

Pharmaceutical aerosol formulations generally comprise a solution or a suspension. A mixture of a suspension and a small amount of dissolved medicament is also possible, but generally undesirable (as described below). Some solution formulations have the disadvantage that the drug substance contained therein is more susceptible to degradation than when in solid form. Furthermore, solution formulations may be associated with problems in controlling the size of the droplets which in turn affects the therapeutic profile. Suspension formulations are thus generally preferred.

To obtain regulatory approval, pharmaceutical aerosol formulation products must satisfy strict specifications. One parameter that must generally be satisfied, and for which a level is usually specified, is the fine particle mass (FPM). The FPM is a measure of the amount of drug that has the potential to reach the inner lungs (the small bronchioles and alveoli) based on the proportion of drug particles with a diameter within a certain range, usually less than 5 microns. The FPM of an actuation from an MDI is generally calculated on the basis of the sum of the amount of drug substance deposited on stages 3, 4 and 5 of an Andersen Cascade Impaction stack as determined by standard HPLC analysis. Potental side effects are minimised and a smaller amount of drug substance is wasted if the FPM constitutes as large as possible a percentage of the total mass of drug.

In suspension formulations, particle size of the emitted dose is generally controlled during manufacture by the size to which the solid medicament is reduced, usually by micronisation. During storage of some drug suspensions in an HFA, however, various changes have been found to take place which have the effect of reducing FPM. A drop in FPM means that the therapeutically effective amount of drug available to the patient is reduced. That is undesirable and may ultimately impact on the effectiveness of the medication. That problem is particularly acute when the dose due to be dispensed is low, which is the case for certain potent drugs such as long acting beta agonists, which are bronchodilators.

Various mechanisms have been proposed by which the reduction in FPM may be taking place: particle size growth may occur if the suspended drug has a sufficient solubility in propellant, a process known as Ostwald Ripening. Alternatively, or additionally, small particles may have the tendency to aggregate or adhere to parts of the inside of the MDI, for example the canister or valve. Small particles may also become absorbed into or adsorbed onto rubber components of the valve. As adherence and absorption processes are more prevalent amongst small particles, those processes lead to a decrease in FPM as a fraction of the administered drug as well as a reduction in the total drug content (TDC) of the canister available to patient. It has further been found that the adherence and absorption processes may not only result in loss of available drug, but may also adversely affect the function of the device, resulting in the valve sticking or orifices becoming blocked.

It is essential that the prescribed dose of aerosol medication delivered from the MDI to the patient consistently meets the specifications claimed by the manufacturer and complies with the requirements of the FDA and other regulatory authorities. That is, every dose dispensed from the MDI must be the same within close tolerances. Therefore it is important that the formulation be substantially homogenous throughout the canister and the administered dose at the time of actuation of the metering valve and that it remains substantially the same even after storage.

Various approaches have been taken to address the problems mentioned above. One approach is the addition of one or more adjuvants to the drug suspension; for example adjuvants selected from alcohols, alkanes, dimethyl ether, surfactants (e.g. fluorinated or non-fluorinated surfactants, carboxylic acids, polyethoxylates, etc.) and even conventional chlorofluorocarbon propellants in small amounts (at levels intended to keep to a minimum potential ozone damage) have been shown to have some effect in mitigating the FPM problems. Such approaches have been disclosed, for example, in EP0372777, W091/04011, W091/11173, W091/11495 and W091/14422. W092/00061 discloses non-fluorinated surfactants for use with fluorocarbon propellants. Fluorinated surfactants may be used to stabilise micronised drug suspensions In fluorocarbon propellants such as 1,1,1,2-tetrafluoroethane (P134a) or 1,1,1,2,3,3,3-heptafluoro-n-propane (P227), see for example U.S. Pat. No. 4,352,789, U.S. Pat. No. 5,126,123, U.S. Pat. No. 5,376,359, U.S. application Ser. No. 09/580008, WO91/11173, WO91/14422, WO92/00062 and WO96/09816.

In WO96/32345, WO96/32151, WO96/32150 and WO96/32099 there are disclosed aerosol canisters coated with one or more fluorocarbon polymers, optionally in combination with one or more non-fluorocarbon polymers, that reduce the deposition on the canister walls of drug particles of the pharmaceutical alternative propellant aerosol formulation contained therein.

In WO 03/049786 it is described that deposition of drug on an elastomeric seal, and several other problems associated with lubrication, flexibility and sealing ability of an elastomeric seal may be overcome by the addition of an organotitanium low friction barrier coating to the seal surface. A pre-treatment step in which the elastomeric seal is treated as follows is also disclosed therein: the elastomeric substrate is provided in a bath comprising an alcohol and an alkaline material at a bath temperature effective for treatment, ultrasonic energy is provided to the bath at a treatment effective frequency and power level for a time sufficient to treat the elastomeric substrate, the treated elastomeric substrate is rinsed with de-ionised water; and the treated and rinsed elastomeric substrate is dried. The pre-treatment step is said to permit superior adhesion and bonding of the organotitanium-based coating. In general, however, additional material coating steps add to the expense of manufacturing the final drug product and the presence of a coating may cause additional toxicity and safety tests to be necessary.

The present invention is concerned with an alternative, less burdensome procedure for treating MDI seals, and methods and articles associated therewith.

### SUMMARY OF THE INVENTION

The invention provides a method of treating an elastomeric MDI sealing gasket, which method comprises a step of washing the gasket in an aqueous solution of an alkali. In particular, the invention provides a method of treating an elastomeric MDI sealing gasket, which method comprises a step of washing the gasket in an alkali wash solution that is a solution of an alkali metal hydroxide in water.

It has surprisingly been found that an MDI sealing gasket that has been treated in accordance with the invention has advantageous properties in use. The drop in FPM after prolonged storage of drug substance is much reduced in an MDI comprising one or more sealing gaskets of the invention in comparison with the effects observed after storage in an MDI comprising one or more untreated gaskets. It has also been found that the absolute FPM measurements (before or after storage) are higher in an MDI comprising one or more treated gaskets than in an MDI with untreated gaskets. Without being bound by any particular theory, it Is, at the time of filing, hypothesised that the present invention provides advantageous stabilisation of the aerosol formulation by one or more of the following effects: reducing drug deposition, improving stability of FPM even after storage, decreasing the increase in mean mass aerodynamic diameter (MMAD) during storage, or decreasing the GSD (Geometric Standard Deviation). It is further hypothesised that the effects are caused by removal from the gasket of fatty acids and/or other leachable materials. In a preliminary experiment, it was shown that the effects of the alkali metal hydroxide wash were reversed when the residue extracted from gaskets was re-applied to a treated gasket, suggesting that removal of certain substances from the gasket material is involved in the observed improvements.

Preferably, the MDI sealing gasket is washed before being attached to a metering valve. Optionally, the MDI sealing gasket Is washed in accordance with the invention whilst being a part of a metering valve.

The invention also provides a method of making an elastomeric MDI sealing gasket comprising the steps of:

a) washing a piece of elastomer in an alkali wash solution that is a solution of an alkali metal hydroxide in water;

b) punching, cutting or forming an MDI gasket from the washed elastomer.

Preferably, the elastomer is provided as a sheet. Optionally, the elastomer may be provided in the form of a tube.

Similarly, the invention also provides a method of making an elastomeric MDI sealing gasket comprising the step of punching, cutting or forming an MDI gasket from a piece of elastomer that has been washed in an alkali wash solution that is a solution of an alkali metal hydroxide in water.

The invention further provides a method of making an elastomeric MDI sealing gasket comprising the steps of:

a) punching, cutting or forming an MDI gasket from a piece of elastomer;

b) washing the MDI gasket in an alkali wash solution that is a solution of an alkali metal hydroxide in water.

The invention also provides a method of making an elastomeric MDI sealing gasket comprising the steps of

a) washing base polymer starting material in an alkali wash solution that is a solution of an alkali metal hydroxide in water;

b) producing elastomer from the treated raw polymer;

c) punching, cutting or forming an MDI gasket from the elastomer.

Similarly, the invention also provides a method of making an elastomeric MDI sealing gasket comprising the step of punching, cutting or forming an MDI gasket from a piece of elastomer that has been produced from base polymer starting that has been washed in an alkali wash solution that is a solution of an alkali metal hydroxide in water.

Preferably, the alkali metal hydroxide is sodium hydroxide or potassium hydroxide, most preferably sodium hydroxide. Preferably, the alkali metal hydroxide is present at a concentration of from 0.005M to 5.0M, more preferably from 0.05M to 2.0M, most preferably from 0.1M to 1.0M.

Preferably, the washing step in the method of the invention is carried out at a temperature of from 20° C. to boiling point. More preferably, the washing step is carried out at a temperature of from 40° C. to boiling point. Still more preferably, the washing step is carried out at a temperature of from 60° C. to boiling point. Most preferably, the washing step takes place under reflux.

Typically the washing step is carried out for from 15 minutes to 48 hours. Preferably the washing step is carried out for from 1 to 12 hours, more preferably from 2 to 10 hours, most preferably from 4 to 8 hours, for example approximately 6 hours. The MDI sealing gasket may be one comprising low density polyethylene, chlorobutyl or acrylonitrile butadiene rubber, butyl rubber, a polymer of ethylene propylene diene monomer (EPDM), neoprene or chloroprene. The elastomeric material from which the gasket is made may be carbon-black or mineral filled. Preferably the MDI sealing gasket is one made from an acrylonitrile butadiene polymer (also known as an acrylonitrile butadiene rubber) or a polymer of ethylene propylene diene mohomer (EPDM). More preferably the polymer is an acrylonitrile butadiene polymer.

Preferably the alkali solution wash step is the last treatment step that significantly affects the properties of the gasket. Further optional steps may include rinsing the treated gasket with a neutralising solution or water (for example distilled or de-ionised water) and drying the gasket. Other treatment steps may be included in the overall treatment process. The gasket may, for example, be washed with detergent and or bleach. Such a further wash step preferably occurs prior to the alkali wash of the invention. It is preferred that the gasket is not coated with an organotitanium coating. It is preferred that the treatment in accordance with the invention does not include providing ultrasonic energy to the elastomer.

The invention further provides a sealing gasket for use in an inhaler which seal has been treated by a method In accordance with the invention or has been made by a method in accordance with the invention. Herein the term “gasket” is used interchangeably with the terms “sealing gasket” or “seal”.

The invention further provides a method of manufacturing an MDI comprising providing an MDI sealing gasket that has been treated in accordance with the invention, providing the other MDI components and a pharmaceutical aerosol formulation and assembling the MDI. The pharmaceutical aerosol formulation may comprises any suitable medicament, for example an anti-asthmatic, for example a bronchodilator or an anti-inflammatory, particularly of steroid type, having a local therapeutic action in the lungs and/or a systemic action after absorption into the blood. The pharmaceutical aerosol formulation may comprise salbutamol particularly as the sulphate, 3-(4-{[6-({(2R)-2-hydroxy-2-[4-hydroxy-3-(hydroxymethyl)phenyl]ethyl}amino)hexyl}3-(3-{[7-({(2R)-2-hydroxy-2-[4-hydroxy-3-hydroxymethyl)phenyl]ethyl}-amino)heptyl]oxy}propyl)benzenesulfonamide, 4-(1 R)-2-[(6-{2-[(2,6-dichlorobenzyl)oxy]ethoxy}hexyl)amino]-1-hydroxyethyl}-2(hydroxymethyl)phenol, 6α,9α-difluoro-17α-(2-furanylcarbonyl)oxy]-11β-hydroxy-16α-methyl-3-oxo-androsta-1,4-diene-17β-carbothioic acid S-fluoromethyl ester, 6α,9α-difluoro-11β-hydroxy-16α-methyl-17α-[(4-methyl-1,3-thiazole-5-carbonyl)oxy]-3-oxo-androsta-1,4-diene-170-carbothioic acid S-fluoromethyl ester, N-(3,5-dichloropyridin-4-yl)-2-[1-(4-fluorobenzyl)-5-hyroxyindol-3-yl]-2-oxoacetamide, a compound of formula (II) or claim as disclosed in W001/42193, a compound of formula (I) as disclosed in WO03/042160, or a compound of formula (I) as disclosed In WO03/042164.

Preferably, the pharmaceutical aerosol formulation comprises salmeterol xinafoate, fluticasone propionate or a combination of those with each other and/or with one or more further medicaments.

The invention further provides a container comprising a canister sealed with a metering valve and a sealing gasket, which canister contains a pharmaceutical aerosol formulation comprising a propellant and a medicament, wherein the sealing gasket is one in accordance with the invention. A container according to the invention is preferably a sealed container capable of withstanding the pressure required to maintain the propellant as a liquid.

Especially preferred is a container with a metering valve comprising a metering chamber defined by walls and an upper and a lower sealing gasket through which passes a valve stem. Optionally, the one or more of the sealing gaskets within the metering valve may be sealing gaskets in accordance with the invention.

The invention further provides a metering valve suitable for metering a drug suspension comprising a medicament and a propellant, which metering valve comprises a valve body, a metering chamber, a valve stem and one or more sealing gaskets in accordance with the invention. A metering valve according to the invention incorporates a gasket to prevent leakage of propellant through the valve. Such a metering valve is preferably designed to deliver a metered amount of the formulation per actuation.

The invention metered dose inhaler comprising a canister in communication with a metering valve suitable for metering a drug suspension comprising a medicament and a liquid propellant, wherein the metering valve and the canister are sealed with a sealing gasket in accordance with the invention. Metered dose inhalers are designed to deliver a fixed unit dosage of medicament per actuation or “puff”, for example, in the range of 2.5 to 5000 micrograms of medicament per puff, preferably in the range of from 5.0 to 2500 micrograms per puff.

The invention further provides a drug product comprising a canister containing a drug suspension comprising a propellant and a medicament in communication with a metering valve suitable for metering a drug suspension comprising a medicament and a liquid propellant, wherein the metering valve and the canister are sealed with one or more sealing gaskets.

There is also provided a package comprising a metered dose inhaler in accordance with the invention contained within a flexible wrapper, said wrapper being composed of a material that is substantially permeable to evacuation of propellant gas and substantially impermeable to intrusion of atmospheric moisture.

The invention also provides a method of treating asthma, rhinitis or COPD in a patient which comprises use by the patient of a metered dose inhaler in accordance with the invention.

In a further aspect, the invention also provides a method of prolonging the shelf-life of a metered dose inhaler drug product comprising the step of assembling the metered dose inhaler from parts including one or more sealing gaskets in accordance with the invention.

The invention further provides the use of a gasket in accordance with the invention a method of manufacturing an MDI for providing a dispensed drug aerosol with higher FPM than an MDI with an untreated seal or gasket. The invention also provides the use of a gasket in accordance with the invention in a method of manufacturing an MDI for providing a dispensed aerosol with an Improved FPM storage stability in comparison with an MDI with an untreated sealing gasket. Additionally the invention provides the use of a gasket in accordance with the invention for increasing the shelf-life of a HFA suspension formulation in comparison with a corresponding formulation stored in a MDI with an untreated gasket.

The invention further provides a sealing gasket comprising an elastomer characterised in that said gasket is a washed gasket from which 0.5% by weight or less such as 0.001 to 1% by weight of the gasket has been extracted with an alkali wash solution that is a solution of an alkali metal hydroxide in water.

The invention further provides a container comprising a sealing gasket according to the invention wherein said container is sealed with a metering valve and contains a pharmaceutical aerosol formulation comprising a particulate medicament and a liquefied HFA propellant, said container characterised in that the FPM of the particulate medicament is maintained within 15%, more preferably within 10% and especially 5% of its original level after 12 weeks storage at 40° C. and 75% relative humidity.

The invention further provides the use of sodium hydroxide in a gasket washing step for providing a seal or a gasket which, when incorporated into an MDI provides an MDI which has a dispensed drug aerosol with higher FPM than an MDI with an untreated sealing gasket. There is also provided the use of sodium hydroxide in a seal or gasket washing step for providing a seal or a gasket which, when incorporated into an MDI provides an MDI which has a dispensed drug aerosol with an improved FPM storage stability in comparison with an MDI with an untreated sealing gasket.

The invention finds particular application in MDIs for use with therapeutic agents that are antiasthmatics, including bronchodilators and antiinflammatories, particularly of steroid type, having a local therapeutic action in the lungs and/or a systemic therapeutic action after absorption in the blood. 4-Hydroxy-α¹-[[[6-(4-phenylbutoxy)hexyl]amino]methyl]-1,3-benzene dimethanol was described as one of a wide range of bronchodilators in GB-A-2140800. That compound is also known by the generic name of salmeterol, the xinafoate salt of which has become widely known as a highly effective treatment of inflammatory diseases, such as asthma and chronic obstructive pulmonary disease (COPD). Fluticasone propionate is one of a range of topical anti-inflammatory corticosteroids with minimal liability to undesired systemic side effects which is described in GB-A-2088877, and is systematically named S-fluoromethyl 6α,9α-difluoro-11β-hydroxy-16α-methyl-17α-propionyloxy-3-oxoandrosta-1,4-diene-17β-carbothioate.

Preferably, the medicament is a combination of salmeterol xinafoate and fluticasone propionate. Preferably, no further medicament substances are present.

However, further to the medicaments already disclosed in this specification, MDIs of the present invention are also suitable for dispensing any medicaments which may be administered in aerosol formulations and useful in inhalation therapy e.g.; anti-allergics, e.g. cromoglycate (e.g. as the sodium salt), ketotifen or nedocromil (e.g. as sodium salt); anti-inflammatory steroids, e.g. beclomethasone (e.g. as dipropionate), fluticasone (e.g. as propionate), flunisolide, budesonide, rofleponide, mometasone (e.g as furoate), ciclesonide, triamcinolone acetonide; anticholinergics, e.g. ipratropium (e.g. as bromide), tiotropium, atropine or oxitropium and salts thereof. It will be clear to a person skilled in the art that, where appropriate, the medicaments may be used in the form of salts, (e.g. as alkali metal or amine salts or as acid addition salts) or as esters (e.g. lower alkyl esters) or as solvates (e.g. hydrates) to optimise the activity and/or stability of the medicament and/or to minimise the solubility of the medicament in the propellant. Medicament may be used in the form of racemate or in the form of a pure isomer e.g. R-salmeterol or S-salmeterol. Formulations combining one or more the disclosed medicaments are also within the remit of this disclosure.

The container, MDI and valve described herein are particularly useful for medicaments which present similar formulation difficulties to those described above e.g. because of their susceptibility to water ingress, drug deposition, and other drug losses. Generally, those difficulties are especially severe for potent medicaments which are administered at low doses.

The particle size of the particulate (e.g. micronised) medicament should be such as to permit inhalation of substantially all of the medicament into the lungs upon administration of the aerosol formulation and will thus be less than 100 microns, desirably less than 20 microns, and preferably in the range 1-10 microns, e.g. 1-5 microns.

The concentration of medicament in the formulation will generally be 0.01-10% such as 0.01-2%, particularly 0.01-1%, especially 0.03-0.25% w/w. When salmeterol xinafoate is the only medicament, its concentration in the formulation will generally be 0.03-0.15% w/w.

The formulations according to the present invention may optionally contain one or more further ingredients conventionally used in the art of pharmaceutical aerosol formulation. Such optional ingredients include, but are not limited to, taste masking agents, sugars, buffers, antioxidants, water and chemical stabilisers.

It is desirable that the formulations of the invention contain no components which may provoke the degradation of stratospheric ozone. In particular it is desirable that the formulations are substantially free of chlorofluorocarbons such as CCl₃F, CCl₂F₂ and CF₃GCl₃. If desired the propellant may additionally contain a volatile adjuvant such as a saturated hydrocarbon, for example, propane, n-butane, Isobutane, pentane and isopentane or a dialkyl ether, for example, dimethyl ether. In general, up to 50% w/w of the propellant may comprise a volatile hydrocarbon, for example 1 to 30% w/w. However, formulations which are substantially free of volatile adjuvants are preferred. In certain cases, it may be desirable to include appropriate amounts of water, which can be advantageous in modifying the dielectric properties of the propellant.

Polar adjuvants which may, if desired, be incorporated into the formulations according to the present invention include, for example, C₂₋₆aliphatic alcohols and polyols such as ethanol, isopropanol and propylene glycol and mixtures thereof. Preferably, ethanol will be employed. In general only small quantities (e.g. 0.05 to 3.0% w/w) of polar adjuvants are required and the use of quantities in excess of 5% w/w may disadvantageously tend to dissolve the medicament. Formulations preferably contain less than 1% w/w, for example, about 0.1% w/w of polar adjuvant. Polarity may be determined, for example, by the method described in European Patent Application Publication No. 0327777. In some embodiments, it is desirable that the formulations of the invention are substantially free of polar adjuvants. “Substantially free” will generally be understood to mean containing less than 0.01% especially less than 0.0001% based on weight of formulation.

Preferably a single propellant is employed, for example, 1,1,1,2-tetrafluoroethane (HFA 134a) or 1,1,1,2,3,3,3-heptafluoro-n-propane (HFA 227), especially 1,1,1,2-tetrafluoroethane. It is desirable that the formulations of the Invention contain no components which may provoke the degradation of stratospheric ozone. In particular it is desirable that the formulations are substantially free of chlorofluorocarbons such as CCl₃F, CCl₂F₂ and CF₃CCl₃.

Whilst a suitable surfactant may be employed preferably the formulations of the invention are substantially free of surfactant. “Substantially free” will generally be understood to mean containing less than 0.01% w/w especially less than 0.0001% based on weight of formulation.

The formulations for use in the invention may be prepared by dispersal of the medicament in the selected propellant in an appropriate container, for example, with the aid of sonication or a high-shear mixer. The process is desirably carried out under controlled humidity conditions.

The term “sealing gasket” when used in this specification will be understood to mean a neck/canister gasket and/or lower sealing gasket and/or upper sealing gasket. The latter two gaskets being those associated with the metering chamber. Most preferably in canisters according to the invention the neck/canister gasket is the only gasket washed according to the invention.

The term “metered dose inhaler” or “MDI” means a unit comprising a canister, a secured cap covering the canister and a formulation metering valve situated in the cap. A fully assembled MDI includes a suitable channelling device. Suitable channelling devices comprise, for example, a valve actuator and a cylindrical or cone-like passage through which medicament may be delivered from the filled canister via the metering valve to the nose or mouth of a patient e.g. a mouthpiece actuator.

MDI canisters generally comprise a container capable of withstanding the vapour pressure of the propellant used such as a plastic or plastics-coated glass bottle or preferably a metal canister, for example, of aluminium or an alloy thereof which may optionally be anodised, lacquer-coated and/or plastic-coated (e.g. incorporated herein by reference WO96/32150 wherein part or all of the internal surfaces of the can are coated with one or more fluorocarbon polymers optionally in combination with one or more non-fluorocarbon polymers).

The cap may be secured onto the canister via welding such as ultrasonic welding or laser welding, screw fitting or crimping. MDIs taught herein may be prepared by methods of the art (e.g., see Byron, above and WO/96/32150). Preferably the canister is fitted with a cap assembly, wherein a formulation metering valve is situated in the cap, and said cap is crimped in place.

The metering chamber (especially when composed of a plastics material) may be surface treated so as to present a substantially fluorinated surface to the formulation. Alternatively the metering chamber (especially when composed of a plastics material) may be surface treated with a siloxane such as dimethyl siloxane. As a further alternative, the metering chamber presents a substantially fluorinated surface to the formulation by virtue of being composed of a suitable substantially fluorinated material. Suitable metering chambers and surface treatments for metering chambers are described in WO 02/51483 at page 7, line 15 to page 11, line 18.

The invention also relates to a container as described above wherein the valve stem presents a substantially fluorinated surface to the formulation. Suitable valve stems and surface treatments for valve stems are described in WO 02/51483 at page 11, line 21 to page 12, line 3.

Preferably the container according to the invention comprises a canister composed of aluminium. Suitable surface treatments for a canister are described in WO 02/51483 at page 12, lines 10 to 16.

In a further aspect of the invention, there is provided a package comprising an MDI as described above within a flexible wrapper, said wrapper being composed of a material which is substantially permeable to evacuation of propellant gas and substantially impermeable to intrusion of atmospheric moisture e.g. as described in U.S. Pat. No. 6,119,853. Preferably the package will also contain within it a desiccant material. The desiccant material may be inside the MDI system and/or outside the MDI system.

Conventional bulk manufacturing methods and machinery well known to those skilled in the art of pharmaceutical aerosol manufacture may be employed for the preparation of large scale batches for the commercial production of filled canisters. Thus, for example, in one bulk manufacturing method a metering valve is crimped onto an aluminium can to form an empty canister. The particulate medicament is added to a charge vessel and liquefied propellant Is pressure filled through the charge vessel into a manufacturing vessel, together with liquefied propellant containing the surfactant. The drug suspension is mixed before recirculation to a filling machine and an aliquot of the drug suspension is then filled through the metering valve into the canister.

In an alternative process, an aliquot of the liquefied formulation is added to an open canister under conditions which are sufficiently cold such that the formulation does not vaporise, and then a metering valve crimped onto the canister.

Typically, in batches prepared for pharmaceutical use, each filled canister is check-weighed, coded with a batch number and packed into a tray for storage before release testing.

Each filled canister is conveniently fitted into a suitable channelling device, prior to use, to form a metered dose inhaler system for administration of the medicament into the lungs or nasal cavity of a patient.

The chemical and physical stability and the pharmaceutical acceptability of the aerosol formulations according to the invention may be determined by techniques well known to those skilled in the art. Thus the chemical stability of the components may be determined by HPLC assay, for example, after prolonged storage of the product. Physical stability data may be gained from other conventional analytical techniques such as by leak testing, by valve delivery assay (average shot weights per actuation), by dose reproducibility assay (active ingredient per actuation) and spray distribution analysis.

The suspension stability of the aerosol formulations according to the invention may be measured by conventional techniques, for example, by measuring flocculation size distribution using a back light scattering instrument or by measuring aerodynamic particle size distribution by cascade impaction, next generation impactor, multistage liquid impinger, or by the “twin impinger” analytical process. As used herein reference to the “twin impinger” assay means “Determination of the deposition of the emitted dose in pressurised inhalations using apparatus A” as defined in British Pharmacopaeia 1988, pages A204-207, Appendix XVII C. Such techniques enable the “respirable fraction” of the aerosol formulations to be calculated. One method used to calculate the “respirable fraction” is by reference to “fine particle fraction” which is the amount of active ingredient collected in the lower impingement chamber per actuation expressed as a percentage of the total amount of active ingredient delivered per actuation using the twin impinger method described above. As discussed above, the absolute “fine particle mass” (FPM) is an important parameter in relation to the present invention. The FPM may be assessed using the same apparatus as the fine particle fraction.

Administration of medicament in a container or MDI in accordance with the invention may be indicated for the treatment of mild, moderate, severe acute or chronic symptoms or for prophylactic treatment. It will be appreciated that the precise dose administered will depend on the age and condition of the patient, the particular particulate medicament used and the frequency of administration and will ultimately be at the discretion of the attendant physician. When combinations of medicaments are employed the dose of each component of the combination will in general be that employed for each component when used alone. Typically, administration may be one or more times, for example, from 1 to 8 times per day, giving for example 1, 2, 3 or 4 puffs each time.

Suitable daily doses, may be, for example, in the range 50 to 200 micrograms of salmeterol or 50 to 2000 micrograms of fluticasone propionate, depending on the severity of the disease. Thus, for example, each valve actuation may deliver 25 micrograms of salmeterol or 25, 50, 125 or 250 micrograms of fluticasone propionate. Doses for Seretide198 , which is a combination of salmeterol (e.g. as xinafoate salt) and fluticasone propionate, will usually be those given for the corresponding individual component drugs. Typically each filled canister for use in a metered dose inhaler contains 60, 100,120,160 or 240 metered doses or puffs of medicament.

An appropriate dosing regime for other medicaments will be known or readily available to persons skilled in the art.

The invention will now be described further with reference the following Examples which serve to illustrate the invention but is not intended to be limiting.

### EXAMPLES

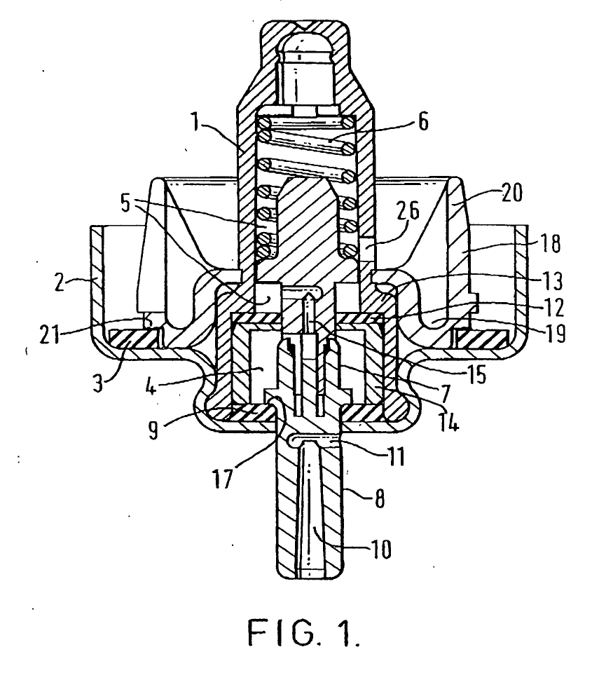

FIG. 1 shows part of a cross-section view of the valve end of an MDI container with the valve pointing downward. The main sealing gasket is represented by 3 the can/neck seal; The figure also shows the lower metering chamber seal 9 and the upper metering chamber seal 12.

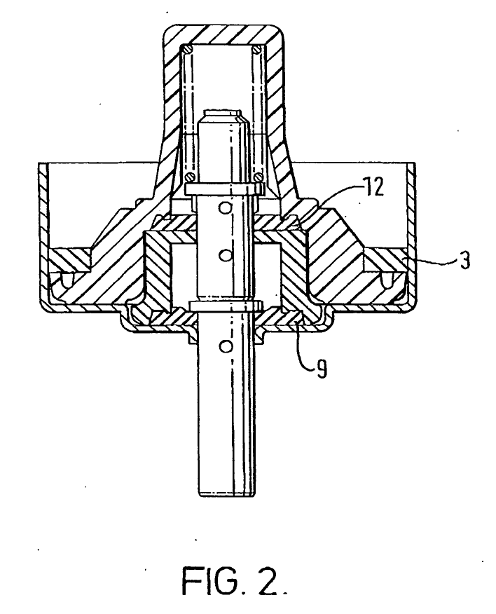

FIG. 2 shows part of a cross-section view of the valve end of an alternative MDI container with the valve pointing downward.

FIG. 3 is a graph showing the cascade impaction FPM for formulations of salmeterol xinafoate and fluticasone propionate in MDIs with various gaskets.

1. An Example MDI

The valve body 1 is formed at its lower part with a metering chamber 4, and its upper part with a sampling chamber 5 which also acts as a housing for a return spring 6. The metering chamber is constructed from a fluorinated polymer at least in part and/or a fluorinated coating. The words “upper” and “lower” are used for the container when it is in a use orientation with the neck of the container and valve at the lower end of the container which corresponds to the orientation of the valve as shown in FIG. 1. Inside the valve body 1 is disposed a valve stem 7, a part 8 of which extends outside the valve through lower stem seal 9 and ferrule 2. The stem part 8 is formed with an inner axial or longitudinal canal 10 opening at the outer end of the stem and in communication with a radial passage 11.

The upper portion of stem 7 has a diameter such that it can slide through an opening in an upper stem seal 12 and will engage the periphery of that opening sufficiently to provide a seal. Upper stem seal 12 is held in position against a step 13 formed in the valve body 1 between the said lower and upper parts by a sleeve 14 which defines the metering chamber 4 between lower stem seal 9 and upper stem seal 12. The valve stem 7 has a passage 15 which, when the stem is in the inoperative position shown, provides a communication between the metering chamber 4 and sampling chamber 5, which itself communicates with the interior of the container via orifice 26 formed in the side of the valve body 1.

Valve stem 7 is biased downwardly to the inoperative position by return spring 6 and is provided with a shoulder 17 which abuts against lower stem seal 9. In the inoperative position as shown In FIG. 1 shoulder 17 abuts against lower stem seal 9 and radial passage 11 opens below lower stem seal 9 so that the metering chamber 4 is isolated from canal 10 and suspension inside cannot escape.

A ring 18 having a “U” shaped cross section extending in a radial direction is disposed around the valve body below orifice 26 so as to form a trough 19 around the valve body. As seen in FIG. 1 the ring is formed as a separate component having an inner annular contacting rim of a diameter suitable to provide a friction fit over the upper part of valve body 1, the ring seating against step 13 below the orifice 26. However, the ring 18 may alternatively be formed as an integrally moulded part of valve body 1.

To use the device the container is first shaken to homogenise the suspension within the container. The user then depresses the valve stem 7 against the force of the spring 6. When the valve stem is depressed both ends of the passage 15 come to lie on the side of upper stem seal 12 remote from the metering chamber 4. Thus a dose is metered within the fluorinated metering chamber. Continued depression of the valve stem will move the radial passage 11 into the metering chamber 4 while the upper stem seal 12 seals against the valve stem body. Thus, the metered dose can exit through the radial passage 11 and the outlet canal 10.

Releasing the valve stem causes it to return to the illustrated position under the force of the spring 6. The passage 15 then once again provides communication between the metering chamber 4 and sampling chamber 6. Accordingly, at this stage liquid passes under pressure from the container through orifice 26, through the passage 15 and thence into the metering chamber 4 to fill it.

FIG. 2 shows a view of a different valve in which the gasket seal and lower and upper stem seals are labelled 3, 9 and 12 respectively.

2. Treatment of Valve Gaskets

The valves used in the following experiments were DF60 valves from Valois (France). The sealing gasket (acrylonitrile butadiene polymer) was removed from the valve for treatment.

Experiment A

A 250 ml round bottomed flask was charged with 1M aqueous sodium hydroxide solution (150 ml) was. The gasket was placed in the solution and a condenser was attached to the flask. The solution was then heated under reflux for 6 hours. After that time, the solution was briefly allowed to cool and the sodium hydroxide solution was decanted away. The gasket was then washed three times with 100 ml de-ionised water, removed from the round bottomed flask and dried in a vacuum oven.

The gasket was then re-attached to the valve.

Experiment B

The treatment described above in respect of Experiment A was repeated, and it was further repeated with a 0.1M sodium hydroxide solution also under reflux and with a 0.1M sodium hydroxide solution with heating to 40 degrees C.

3. Sample Preparation

The MDIs for which data are presented in Tables 1 and 2 were prepared in aluminium canisters coated with a PTFE/PES polymer blend as described in WO96/32150 and sealed with a valve prepared as described in 2 above, or with an untreated valve as a control. The aluminium canisters contained a pharmaceutical aerosol formulation comprising 4.2 mg of salmeterol in the form of its xinafoate salt, 8.4 mg of fluticasone propionate and 12 g of HFA 134a.

4. Sample Storage Conditions

Each device was stored at 40° C. and 75% relative humidity unless otherwise stated. FPM was determined shortly after preparation (“initial”) and after one month's storage and, in the case of the Experiment A, after 10 weeks' storage.

5. Method for Determining FPM

Each MDI canister tested was put into a clean actuator and primed by firing 4 shots. Then 10 shots were fired into an Andersen Cascade Impactor which was quantitatively washed and the amount of drug deposited thereon was quantified by HPLC analysis of the washings. From this the dose delivered (the sum of the amount of drug deposited on the cascade impactor) and the FPM (the sum of drug deposited on stages two 3, 4 and 5) data were calculated.

6. Results of FPM Studies with Gaskets Washed with NaOH

Experiment A

TABLE 1

| Sample | FPM initial | FPM 4 weeks | FPM 10 weeks |
|---|---|---|---|
| Control | 12.8 μg | 8.1 μg | 9.5 μg |
| 1.0M NaOH reflux | 13.5 μg | 13.3 μg | 12.8 μg |

The data show that the initial FPM and the FPM after storage are both higher in an MDI with a gasket treated in accordance with the invention than in an MDI with an untreated gasket.

Experiment B

TABLE 2

| Sample | FPM initial | FPM 1 Month |
|---|---|---|
| Control | 14.9 μg | 11.7 μg |
| 0.1M NaOH reflux | 17.8 μg | 16.9 μg |
| 0.1M NaOH 40° C. | 15.9 μg | 12.8 μg |
| 1.0M NaOH reflux | 17.8 μg | 16.2 μg |

The results of Experiment 2 are also shown in FIG. 3. Again, the data show that the initial FPM and the FPM after storage are both higher in an MDI with a gasket treated in accordance with the invention than in an MDI with an untreated gasket.

1. A method of treating an elastomeric MDI sealing gasket, which method comprises a step of washing the gasket in an alkali wash solution that is a solution of an alkali metal hydroxide in water.

2. A method as claimed in claim 1 wherein the alkali metal hydroxide is selected from the group consisting of sodium hydroxide, potassium hydroxide.

3. A method as claimed in claim 2 wherein the alkali metal hydroxide is sodium hydroxide.

4. A method as claimed in claim 1 wherein the washing step is carried out at a temperature of from 40° C. to boiling point.

5. A method as claimed in claim 1 wherein the sealing gasket comprises a polymer of an acrylonitrile butadiene or a polymer of ethylene propylene diene monomer (EPDM).

6. A method of making an elastomeric MDI sealing gasket comprising the steps of:
a) washing a piece of elastomer in an alkali wash solution that is a solution of an alkali metal hydroxide in water; and
b) punching, cutting or forming an MDI gasket from the washed elastomer.

7. (canceled)

8. A method of making an elastomeric MDI sealing gasket comprising the steps of:
a) punching, cutting or forming an MDI gasket from a piece of elastomer; and
b) washing the MDI gasket in an alkali wash solution that is a solution of an alkali metal hydroxide in water.

9-10. (canceled)

11. A sealing gasket for use in an inhaler which sealing gasket has been treated by a method as claimed in claim 1.

12. A method of manufacturing an MDI comprising providing an MDI sealing gasket as claimed in claim 11, providing the other MDI components and a pharmaceutical aerosol formulation and assembling the MDI.

13. A method as claimed in claim 12 wherein the pharmaceutical aerosol formulation comprises salmeterol xinafoate, fluticasone propionate or a combination of those with each other or with one or more further medicaments.

14. A metering valve suitable for metering a drug suspension comprising a medicament and a propellant, which metering valve comprises a valve body, a metering chamber, a valve stem and one or more sealing gaskets as claimed in claim 11.

15. A container comprising a canister sealed with a metering valve and a sealing gasket, which canister contains a pharmaceutical aerosol formulation comprising a propellant and a medicament, wherein the sealing gasket is one as claimed in claim 11.

16. A metered dose inhaler comprising a canister in communication with a metering valve suitable for metering a drug suspension comprising a medicament and a liquid propellant, wherein the metering valve and the canister are sealed with a sealing gasket as claimed in claim 11.

17. A drug product comprising a canister containing a drug suspension comprising a propellant and a medicament in communication with a metering valve suitable for metering a drug suspension comprising a medicament and a liquid propellant, wherein the metering valve and the canister are sealed with one or more sealing gaskets as claimed in claim 11.

18. (canceled)

19. A method of treating asthma or COPD in a patient which comprises use by the patient of a metered dose inhaler as claimed in claim 16.

20. A method of prolonging the shelf-life of a metered dose inhaler drug product comprising the step of assembling the metered dose inhaler from parts including one or more sealing gaskets as claimed in claim 11.

21-24. (canceled)
